(19) United States
(12) Patent Application Publication
(10) Pub. No.: US 2023/0253599 A1
(43) Pub. Date: Aug. 10, 2023

(54) ENERGY STORAGE DEVICES AND COMPONENTS INCLUDING AQUEOUS OXYANION ELECTROLYTES

(71) Applicant: FORM ENERGY, INC., Somerville, MA (US)

(72) Inventors: William Henry WOODFORD, Somerville, MA (US); Yet-Ming CHIANG, Weston, MA (US); Kailash RAMAN, Glendale, AZ (US); Liang SU, Medfield, MA (US); Merrill K. CHIANG, Weston, MA (US)

(21) Appl. No.: 18/049,957

(22) Filed: Oct. 26, 2022

Related U.S. Application Data
(60) Provisional application No. 63/273,746, filed on Oct. 29, 2021.

(51) Int. Cl. H01M 8/16; H01M 8/18

(52) U.S. Cl. CPC H01M 8/16; H01M 8/188

(57) ABSTRACT

Systems, methods, and device of the various embodiments may support energy storage devices in which electrochemical oxidation and reduction of one or more redox-active oxyanions occurs during charging and/or discharging of the energy storage device.

### RELATED APPLICATIONS

This application claims the benefit of priority to U.S. Provisional Patent Application No. 63/273,746 entitled “Energy Storage and Electrodes Comprising Aqueous Oxyanion Solutions” filed Oct. 29, 2021, the entire contents of which are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultralong (collectively, >8 h) energy storage systems.

This Background section is intended to introduce various aspects of the art, which may be associated with embodiments of the present disclosure. Thus, the foregoing discussion in this section provides a framework for better understanding the present disclosure, and is not to be viewed as an admission of prior art.

### SUMMARY

Systems, methods, and device of the various embodiments may support energy storage devices in which electrochemical oxidation and reduction of one or more redox-active oxyanions occurs during charging and/or discharging of the energy storage device.

Various embodiments may include an energy storage device, comprising: at least one electrode configured such that electrochemical oxidation and reduction of one or more redox-active oxyanions occurs during charging and/or discharging of the energy storage device.

Various embodiments may include an energy storage device, comprising: negative electrode materials comprising sulfate and sulfite; and positive electrode materials comprising oxygen, wherein the energy storage device is configured to be rechargeable.

### DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIGS. 1-4 are schematic views of electrochemical energy storage devices, according to various embodiments of the present disclosure.

FIGS. 5A and 5B are schematic views showing discharging and charging of an energy storage device of FIG. 1, according to various embodiments of the present disclosure.

FIGS. 6A and 6B are schematic views showing discharging and charging of an energy storage device of FIG. 2, according to various embodiments of the present disclosure.

FIGS. 7-15 illustrate various example systems in which one or more aspects of the various embodiments may be used as part of bulk energy storage systems.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present disclosure. These examples are for illustrative purposes, may be prophetic, and should not be viewed as limiting, and do not otherwise limit the scope of the present disclosure.

It is noted that there is no requirement to provide or address the theory underlying the novel and groundbreaking processes, materials, performance or other beneficial features and properties that are the subject of, or associated with, embodiments of the present disclosure. Nevertheless, various theories are provided in this specification to further advance the art in this area. The theories put forth in this specification, and unless expressly stated otherwise, in no way limit, restrict or narrow the scope of protection to be afforded the claimed invention. These theories many not be required to utilize the present disclosure. It is further understood that the present disclosure may lead to new, and heretofore unknown theories to explain the function-features of embodiments of the methods, articles, materials, devices, and system of the present disclosure, and such later developed theories shall not limit the scope of protection afforded the present disclosure.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present disclosure should not be limited to a particular embodiment, configuration or arrangement that is set forth in a particular embodiment, example, or in an embodiment in a particular figure.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. Thus, the scope of protection afforded the present inventions should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

Other embodiments include backup power for telecommunications, data centers, electronic devices, transportation signals, medical facilities, or buildings. The duration of power delivery from the battery may range from a few minutes to a few hours. The durations of energy storage and/or power delivery described herein are provided merely as examples and are not intended to be limiting.

Various embodiments provide systems for ultra-long (days, weeks, months, years) energy storage based upon electrochemical oxidation and reduction of oxyanions that include, but are not limited to, electrochemical reactions of aqueous solutions of nitrogen, sulfur, and phosphorus oxyanions. The present systems have advantages in cost, scalability, and safety compared to existing energy storage technologies.

Existing electrochemical energy storage technologies have a high cost of energy capacity ($/kWh), making it economically infeasible to scale them to durations greater than 8 hours. This high cost is largely attributed to the use of expensive raw materials as energy storage media. The presently described system offers ultra-low cost electrochemical energy storage by utilizing abundant oxyanion chemical feedstocks for energy storage.

Various embodiments may include chemical reactants for such an electrochemical energy storage system, supporting materials, such as electrolytes and additives, and/or components of an electrochemical cell or energy storage system. Various embodiments may include the electrochemical cell and its design, as well as auxiliary subsystems aiding in the function of the energy storage system. Various embodiments may include a system comprising the electrochemical cell and subsystems aiding in its function, including but not limited to, subsystems delivering and removing gaseous reactants, subsystems delivering and removing liquid reactants, subsystems providing for interconnection of the energy storage system with electricity inputs and outputs, thermal management subsystems, and/or subsystems providing for electrical or mechanical control of the system, including but not limited to battery management systems (sometimes referred to as BMSs). Various embodiments may also include systems comprising said energy storage system and a source of electricity, including but not limited to a source of renewable electricity.

As used herein the term “redox” may refer to a reduction-oxidation reaction in which a reduction process and an oxidation process occur at the same time. During redox, one reactant loses an electron, thereby being oxidized (i.e., entering an oxidation state) and the other reactant gains an electron, thereby being reduced (i.e., entering a reduction state). Redox-active species may be species changing oxidation state (e.g., undergoing reduction or undergoing oxidation) in a reduction-oxidation reaction.

Various embodiments include electrodes, electrochemical couples, batteries, and energy storage systems comprising redox-active oxyanions, including without limitation nitrate (NO₃²⁻), nitrite (NO₂⁻), sulfate (SO₄²⁻), sulfite (SO₃²⁻), hyposulfite (SO₂²⁻), phosphate (PO₄³⁻), phosphite (PO₃³⁻), hypophosphite (PO₂³⁻), and the like, or combinations thereof. In some embodiments, the redox-active oxyanions may include more highly oxidized or more highly reduced species such as, peroxodisulfate (S₂O₈²⁻), ammonia (NH₃), ammonium (NH₄⁺), or sulfides such as S₂⁻ or HS₂. In some embodiments, the redox-active oxyanions may include chlorite (ClO₂⁻), chlorate (ClO₃⁻), chlorine dioxide (ClO₂), hypochlorite (ClO⁻), and the like, or combinations thereof. In some embodiments, the operation of the energy storage system comprises reversible reduction/oxidation (redox) of one or more of the oxyanion species. In some embodiments, the source of the redox-active species is a salt, including but not limited to a sodium salt, such as sodium nitrate, sodium nitrite, sodium sulfate, sodium sulfite, analogous potassium salts, or an ammonium salt such as ammonium nitrate or ammonium sulfate.

In various embodiments, provided are energy storage devices such as electrochemical cells (e.g., batteries) that include an anode, a cathode, and an aqueous electrolyte in which the redox-active oxyanions may be dissolved. The redox-active oxyanions may be considered to be an electrode active material of either the anode or the cathode, depending on the configuration of the battery.

In some embodiments an energy storage system comprises an electrochemical cell (e.g., battery) or stack or electrochemical cells in which aqueous electrolyte solutions comprising oxyanion compounds are stationary (that is, not pumped). In other embodiments, the aqueous electrolyte solutions are pumped or otherwise moved through the electrochemical stack. In some embodiments, the batteries may operate using a gaseous reactant, such as air, oxygen, or ammonia. As used herein, the term “air” may refer to a general mixture of gases making up an atmosphere, such as Earth's atmosphere (e.g., largely nitrogen, oxygen, and other elements) or other atmospheres (e.g., extraterrestrial atmospheres, selected atmospheres, etc.). In some embodiments, gaseous reactants are passively delivered to the electrochemical cells (that is, are not pumped or otherwise forced under pressure), whereas in other embodiments, said gaseous reactants are pumped or otherwise moved to or within the electrochemical cell. In some embodiments, reduction and oxidation of the gaseous reactant is conducted at a single electrode (also referred to as a bi-functional electrode). In other embodiments, reduction and oxidation of the gaseous reactant are carried out at separate electrodes. In particular embodiments, a gas-diffusion layer (GDL) electrode is used for reduction of the gaseous reactant, and/or a gas-evolution electrode is used for oxidation of the gaseous reactant. In one particular embodiment, the gaseous reactant is oxygen, and the GDL electrode is an oxygen reduction reaction (ORR) electrode, and the gas-evolution electrode is an oxygen evolution (OER) electrode.

Existing scientific literature teaches that sulfite oxidation on graphite is electrolytically irreversible. In contrast, the present inventors surprisingly found that the oxidation of sulfite to sulfate in alkaline solution (e.g., pH=13) occurs reversibly at about +0.6 V vs SHE (standard hydrogen electrode) at room temperature, while the oxygen evolution reaction (OER) occurs at about +1.4 V vs SHE. Various embodiments may include a rechargeable sulfate-oxygen, or sulfate-air, battery comprising sulfate and sulfite as the negative electrode materials and oxygen and/or air, as the positive electrode materials. In some embodiments, such a sulfate-oxygen, or sulfate-air, battery may have an open-cell voltage or operating voltage of about 0.8 V.

In some embodiments, provided are energy storage devices, such as electrochemical cells (e.g., batteries) that include stationary electrolytes (e.g., the electrolytes are not pumped or otherwise circulated during operation of the battery). In other embodiments, provided are energy storage devices that include a circulated electrolyte. For example, a volume of the electrolyte may be circulated between an electrochemical cell or stack of electrochemical cells and an electrolyte reservoir. In some embodiments, a gaseous reactant, such as air, oxygen, or ammonia, may be provided to an electrochemical cell. In some embodiments, gaseous reactants are passively delivered to the electrochemical cell (that is, are not pumped or otherwise injected), whereas in other embodiments, the gaseous reactants are pumped or otherwise provided to or circulated within the electrochemical cell. In some embodiments, reduction and oxidation of the gaseous reactant is conducted at a single electrode (also referred to as a bi-functional electrode). In other embodiments, reduction and oxidation of the gaseous reactant are carried out at separate electrodes. In particular embodiments, a gas-diffusion layer (GDL) electrode is used for reduction of the gaseous reactant, and/or a gas-evolution electrode is used for oxidation of the gaseous reactant. In one particular embodiment, the gaseous reactant is oxygen, and the GDL is an oxygen reduction reaction (ORR) electrode, and the gas-evolution electrode is an oxygen evolution reaction (OER) electrode.

In various embodiments, an electrode, electrochemical cell, battery, and/or energy storage system may be configured such that electrochemical oxidation and reduction of one or more redox-active oxyanions occurs during charging and/or discharging of the energy storage device. In some embodiments, the electrode, electrochemical cell, battery, and/or energy storage system may be configured such that electrochemical conversions between nitrate, nitrite, and/or ammonia occur during charging and/or discharging. In some embodiments, an electrode may include an aqueous solution of sodium nitrate, potassium nitrate, lithium nitrate, magnesium nitrate, calcium nitrate, calcium ammonium nitrate, sodium nitrite, potassium nitrite, lithium nitrite, or mixtures thereof. In some embodiments, the electrode, electrochemical cell, battery, and/or energy storage system may be configured such that electrochemical conversions between sulfate, sulfite, hyposulfite, thiosulfate, dithionite, and/or hydrogen sulfide occur during charging and/or discharging of the energy storage device. In some embodiments, an electrode may include an aqueous solution of an aqueous solution of sodium sulfate, potassium sulfate, magnesium sulfate, ammonium sulfate, sodium sulfite, potassium sulfite, or mixtures thereof. In some embodiments, the electrode, electrochemical cell, battery, and/or energy storage system may be configured such that electrochemical conversions between phosphate, phosphite, and hypophosphite occur during charging and/or discharging of the energy storage device. In some embodiments, an electrode may include an aqueous solution of sodium phosphate, potassium phosphate, disodium hydrogen phosphite, diammonium hydrogen phosphite, or mixtures thereof.

In various embodiments, an electrode, electrochemical cell, battery, and/or energy storage system may comprise one or more biomolecules, enzymes, and/or microorganisms which aid the reduction or oxidization of one or more redox-active species of the electrode, the electrochemical cell, the battery, and/or the energy storage system. As used herein “microorganisms” (also referred to as microbes) refers to microbial organisms, such as bacteria, protozoa, algae, viruses, etc. According to such embodiments, the redox-active species of may include any electrode-active compound serving as a positive or negative electrode, and which stores charge by undergoing changes in oxidation state. Such electrode-active compounds may comprise a solid, liquid, or gas.

Solid electrode-active compounds may comprise intercalation compounds in which the insertion or removal of an ion is accommodated by a change in the valence state of the host, non-limiting examples of which include lithium, sodium, or proton insertion cathodes and anodes used in lithium-ion, sodium-ion, nickel metal hydride, and Zn—MnO₂ alkaline cells. Solid electrode-active compounds may comprise compounds undergoing a phase change upon incorporating a working ion, non-limiting examples of which include the oxidation of zinc metal to zincate, oxidation of iron to iron hydroxide (Fe(OH)₂), iron oxyhydroxide (FeOOH), or iron oxide (e.g., Fe₃O₄ or Fe₂O₃).

Liquid electrode-active compounds may comprise neat or dissolved salts, including nitrogen, sulfur, and phosphorus oxyanions, ammonium, ammonia, and sulfide, as described elsewhere herein. Liquid electrode-active compounds may also include molecular species dissolved in a liquid solvent, such as ammonia, nitrogen, oxygen, chlorine, or bromine dissolved in a nonpolar solvent, or used in the form of a liquid condensed phase including liquid ammonia, liquid nitrogen, liquid oxygen, liquid chlorine, and the like.

Gaseous electrode-active compounds may include molecular species such as ammonia, nitrogen, chlorine, and oxygen in gaseous form.

In various embodiments, the oxidation or reduction of any of the aforementioned electrode-active compounds (e.g., the solid, liquid, and/or gaseous electrode-active compounds discussed above) may be aided (e.g., facilitated, catalyzed, otherwise improved, etc.) by biomolecules, enzymes, and/or microorganisms (e.g., bacteria, etc.).

In some embodiments, the electrode, the electrochemical cell, the battery, and/or the energy storage system may comprise one or more biomolecules, enzymes, microorganisms, or any combination thereof. In certain embodiments, the biomolecules, enzymes, and/or microorganisms (e.g., bacteria, etc.) may serve to catalyze the reduction or oxidation of redox-active oxyanions or other species, or to reduce or oxidize said oxyanions or redox-active species by, for example, carrying out electron transfer reactions. As a non-limiting example, sulfate-reducing and nitrate-reducing bacteria are known and may be used to facilitate or promote the reduction of sulfate to sulfite or hyposulfite, or of nitrate to nitrite. In some embodiments, the microorganisms used are selected from those present and active in environmental or natural denitrification processes, including those where nitrates and nitrates may be reduced to gaseous nitrogen species. In other embodiments, the microorganisms used are selected from those present and active in the natural sulfur cycle.

In various embodiments, the microorganisms used are selected from those tolerant of the chemical and electrochemical operating conditions of the battery. As a non-limiting example of such selection, bioelectrochemical reduction of nitrate has been observed to depend on whether sulphate is simultaneously present, and on the value of the electrical potential. For example, in the absence of sulphate, Shinella-like and Alicycliphilus-like bacteria may be exclusively found on carbon felt cathodes, while Ochrobactrum-like and Sinorhizobium-like bacteria may be found on the cathodes irrespective of sulphate presence and over a range of cathode potentials. As another example of selection of microorganisms for the purposes of the disclosure, aerobic nitrate reduction, defined as reduction in the presence of atmospheric oxygen, is preferably conducted by certain soil bacteria in the genera Pseudomonas, Aeromonas, and Moraxella. In some embodiments, said microorganisms may be anaerobic, and in other embodiments, said microorganisms may be aerobic.

Accordingly, the preferred bacteria for oxyanion reduction in some embodiments of the disclosure may be selected depending on atmospheric conditions, electrolyte composition, pH, and/or the operating electrical potential of a battery. In various embodiments, said redox reactions may be carried out in acidic solution, near neutral or neutral pH solution, or alkaline (basic) solution. In some embodiments, the pH may be between 7 and 14, and the microorganisms used to facilitate reduction or oxidation may selected, or genetically evolved, to be tolerant of high pH environments.

In some embodiments, the electrodes, electrochemical cells, batteries, or energy storage systems of the present disclosure comprise microorganisms from the group comprising sulphate-reducing bacteria (SRB). SRB are anaerobic microorganisms that are known to play an important role in both the sulfur and carbon cycles. In various embodiments, SRB may be present in the electrodes, electrochemical cells, batteries, or energy storage systems of the present disclosure to facilitate redox processes of the redox-active electrodes in accordance with various embodiments. For example, SRBs may include individually, or in combinations, Archaeoglobus fulgidus DSM 4304, Caldivirga maquilingensis IC-167, Desulfotomaculum reducens MI-1, Desulfovibrio vulgaris subsp. vulgaris strain Hildenborough, Desulfovibrio vulgaris subsp. vulgaris DP4, Desulfovibrio desulfuricans G20, Desulfotalea psychrophila LSv54, Synthrophobacter fumaroxidans MPOB, or the like.

In some embodiments, the anode and/or cathode may comprise a dispersed metal, including but not limited to nanoparticles of iron. In certain embodiments, the efficacy of the microorganism(s) in promoting reduction or oxidation is improved by the presence of dispersed metal. For example, it has been found that the microbial reduction of nitrate is enhanced in the presence of nanoparticulate iron.

Certain embodiments of the disclosure comprise a rechargeable battery wherein charging or partial charging, including the reduction of self-discharge, is accomplished by microorganisms that reduce one or more oxidized discharge products of the battery. For example, in embodiments where discharge of the battery is accommodated by the oxidation of one or more of the herein described redox-active species, charging of the battery may be accomplished by microorganisms which reduce said redox active species.

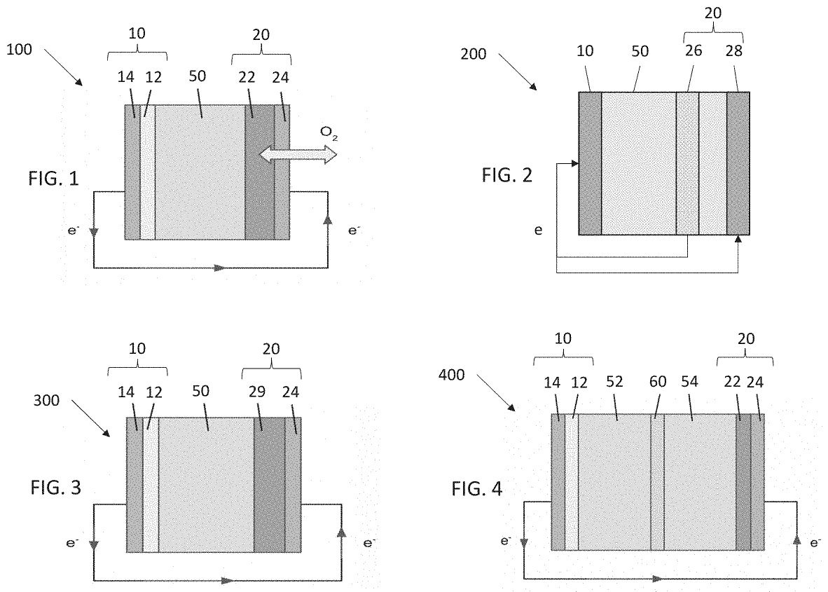

FIG. 1 is a schematic view of an air battery 100, according to various embodiments of the present disclosure. Referring to FIG. 1 the air battery 100 may include an anode 10, an air cathode 20, and an electrolyte 50 disposed therebetween. The anode 10 may include an anode catalyst 12 disposed on a current collector 14. The current collector 14 may comprise graphite, glassy carbon, disordered carbon, graphene, graphene oxide, carbon nanofibers, carbon nanotubes, and/or other fullerenic carbons. The anode catalyst 12 may include, individually, or in combinations, Cu, Ag, Pt, Ti, Fe, Ru, a Cu/Ni alloy, or the like, for example.

The cathode 20 may be a bifunctional cathode configured to operate as an oxygen reduction reaction (ORR) electrode during discharging and may operate as an oxygen evolution reaction (OER) electrode during charging. The cathode 20 may include a cathode catalyst layer 22 disposed on a current collector 24. The current collector 24 may comprise graphite, glassy carbon, disordered carbon, graphene, graphene oxide, carbon nanofibers, carbon nanotubes, and/or other fullerenic carbons. The cathode catalyst layer 22 may include one or more catalysts such as Cu, Ag, Pt, Ti, Fe, Ru, a Cu/Ni alloy, combinations thereof, or the like, for example.

The electrolyte 50 may be an aqueous electrolyte comprising redox-active oxyanions, including, without limitation, nitrate (NO₃²⁻), nitrite (NO₂²⁻), sulfate (SO₄²⁻), sulfite (SO₃²⁻), hyposulfite (SO₂²⁻), phosphate (PO₄³⁻), phosphite (PO₃³⁻), hypophosphite (PO₂³⁻), and the like, or combinations thereof. In some embodiments the redox-active oxyanions may include more highly oxidized or more highly reduced species such as, peroxodisulfate (S₂O₈²⁻), ammonia (NH₃), ammonium (NH₄⁺), or sulfides such as S₂⁻ or HS₂. In some embodiments, the redox-active oxyanions may include chlorite (ClO₂⁻), chlorate (ClO₃⁻), chlorine dioxide (ClO₂), hypochlorite (ClO⁻), and the like, or combinations thereof. A source of the redox-active species may be a salt, including but not limited to, a sodium salt, such as sodium nitrate, sodium nitrite, sodium sulfate, sodium sulfite, analogous potassium salts, or an ammonium salt such as ammonium nitrate or ammonium sulfate.

FIG. 2 is a schematic view of an alternative air battery 200, according to various embodiments of the present disclosure. The battery 200 may be similar to the air battery 100, as such, only the differences therebetween will be discussed in detail.

Referring to FIG. 2, the air battery 200 may include a dual cathode 20 including an OEE electrode 26 and an ORR electrode 28. The OEE electrode 26 may be formed of a metal mesh, such as a Ni mesh, a Ni alloy mesh, or a stainless steel mesh, for example. The ORR electrode 28 may include a hydrophobic portion that is exposed to air and a hydrophilic portion that exposed to the electrolyte 50. The ORR electrode 28 may include ORR catalysts.

FIG. 3 is a schematic view of an alternative battery 300, according to various embodiments of the present disclosure. The battery 300 may be similar to the air battery 100, as such, only the differences therebetween will be discussed in detail.

Referring to FIG. 3, the battery 300 may include a cathode 20 comprising a solid-state cathode material layer 29 and a current collector 24. The cathode material layer 29 may include cathode catalyst and/or a cathode active material selected from iron (III) and/or iron (II) cations, molecular chlorine/chloride, molecular bromine/bromide, and/or manganese (II) oxide/manganese (II) hydroxide, any combination thereof, or the like.

FIG. 4 is a schematic view of an alternative battery 400, according to various embodiments of the present disclosure. The battery 400 may be similar to the air battery 100, as such, only the differences therebetween will be discussed in detail.

Referring to FIG. 4, the battery 400 may include an aqueous anolyte 52, and aqueous catholyte 54, and a separator 60 disposed therebetween. The separator 60 may be an ion exchange membrane, such as a Nafion membrane. The anolyte 52 may include redox-active oxyanions as discussed above. The catholyte 54 may include sodium sulfate, potassium sulfate, magnesium sulfate, ammonium sulfate, sodium sulfite, potassium sulfite, or mixtures thereof, or the like.

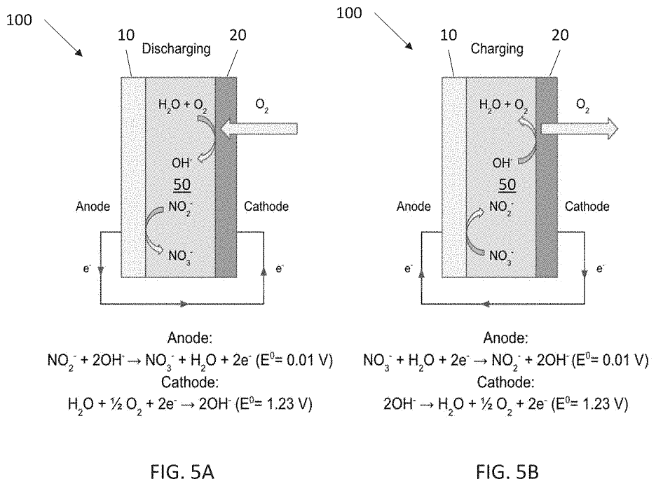

FIGS. 5A and 5B are schematic views respectively illustrating the discharging and charging of an air battery 100 as shown in FIG. 1, using nitrogen compounds as active materials. In particular, the battery 100 may reduce and oxidize mass-produced nitrogen compounds, which span a wide spectrum of oxidation states, in order to store and discharge power. For example, as shown in FIGS. 5A and 5B, the battery 100 may operate using nitrates (NO₃⁺) and nitrites (NO₂⁻) as redox-active oxyanions and ambient air as a source of hydroxyl ions.

Nitrates (NO₃⁻) are the most oxidized class of nitrogen compounds. Nitrate compounds, such as sodium nitrate and potassium nitrate, are used widely in the fertilizer industry. They are readily soluble in water and demonstrate high chemical stability. Nitrates can undergo a two-electron reduction to become nitrites (NO₂⁻). Nitrites possess many similar traits as nitrates in terms of cost, solubility, and stability. Nitrites can undergo an additional six-electron reduction to become ammonia (NH₃). A variety of electrocatalysts can be used to reversibly perform electrochemical conversions between these species in aqueous solutions.

As shown below, half reaction 1 occurs at the anode 10, with NO₃⁻ being generated during discharging and NO₂⁻ being generated during charging, and half reaction 2 occurs at the cathode 20, with oxygen being reduced during discharging (OH⁻ generation and O₂ consumption) and with oxygen being evolved during charging (H₂O and O₂ generation), with the sum of reaction 1 and reaction 2 being net reaction 3:

NO_{3(aq)}⁻+H₂O_{(I)}+2e⁻↔NO_{2(aq)}⁻+2OH⁻_{(aq)}; Reaction 1:

2OH⁻_{(aq)}↔H₂O_{(I)}+½O_{2(g)}2e⁻; and Reaction 2:

NO_{3(aq)}⁻↔NO_{2(aq)}⁻+½O_{2(g)}. Reaction 3:

The charge process (energy storing) drives this process to the right, creating nitrite (NO₂⁻) and oxygen. The discharge process is the oxidation of nitrite to create nitrate (NO₃⁻). The standard reduction potential of reaction (1) above is 0.01 V, while that of reaction (2) is 1.23 V. These two half reactions sum to the overall cell reaction (3), with a standard potential of 1.22 V.

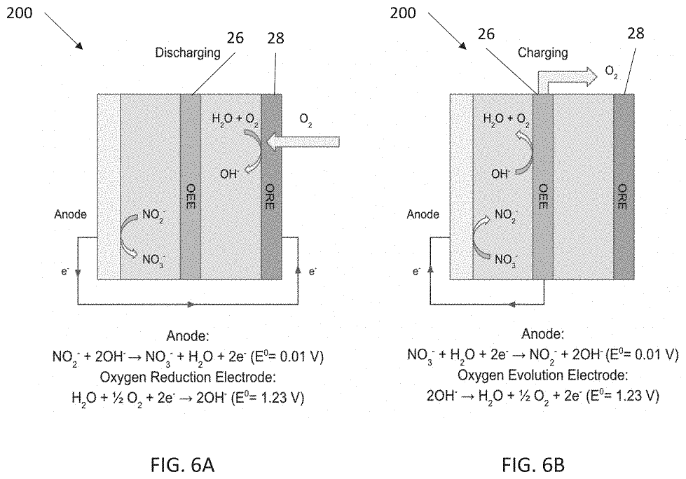

FIGS. 6A and 6B are schematic views respectively illustrating the discharging and charging of an air battery 200 as shown in FIG. 2, using nitrogen compounds as active materials. As shown in FIGS. 6A and 6B, during discharging, hydroxyl generation occurs at the ORR electrode 28, and during charging, oxygen evolution reactions occur at the OER electrode 26. In other words, the charging and discharging reactions are split between the two cathode electrodes 26, 28, which may reduce impedance and improve power storage efficiency.

The following Table 1 includes oxyanion electrode reactions and corresponding battery components that may be used in various embodiments to store and discharge power in electrochemical cells of the present disclosure.

TABLE 1

| Half Reactions | E⁰ (V) | Reagents | Catalysts | Electrode | Phase |
|---|---|---|---|---|---|
| NO₃⁻ + H₂O + | 0.01 | NaNO₃, KNO₃, | Cu, Ag, | Anode, | Aqueous |
| 2e⁻ ↔ NO₂⁻ + | | NH₄NO₃, LiNO₃, | Pt, | Cathode | |
| 2OH⁻ | | Mg(NO₃)₂, | Cu/Ni | | |
| | | Ca(NO₃)₂, | alloy | | |
| | | Ca(NO₃)₂/NH₄NO₃ | | | |
| NO₃⁻ + 6H₂O + | −0.12 | NaNO₃, KNO₃, | Cu/Ni | Anode, | Aqueous, |
| 8e⁻ ↔ NH₃ + | | NH₄NO₃, LiNO₃, | alloy, | Cathode | gas/liquid |
| 9OH⁻ | | Mg(NO₃)₂, | Ti, Fe, | | |
| | | Ca(NO₃)₂, | Ru | | |
| | | Ca(NO₃)₂/NH₄NO₃ | | | |
| NO₂⁻ + 5H₂O + | −0.16 | NaNO₂, KNO₂, | Cu/Ni | Anode, | Aqueous, |
| 6e⁻ ↔ NH₃ + | | LiNO₂ | alloy, | Cathode | gas/liquid |
| 7OH⁻ | | | Ti, Fe, | | |
| | | | Ru | | |
| SO₄²⁻ + H₂O + | −0.93 | Na₂SO₄, MgSO₄, | | Anode | Aqueous |
| 2e⁻ ↔ SO₃²⁻ + | | K₂SO₄, (NH₄)₂SO₄ | | | |
| 2OH⁻ | | | | | |
| 2SO₃²⁻ + 2H₂O + | −1.12 | Na₂SO₃, K₂SO₃ | | Anode | Aqueous |
| 2e⁻ ↔ S₂O₄²⁻ + | | | | | |
| 4OH⁻ | | | | | |
| 2SO₃²⁻ + 3H₂O + | −0.57 | Na₂SO₃, K₂SO₃ | | Anode | Aqueous |
| 4e⁻ ↔ S₂O₃²⁻ + | | | | | |
| 6OH⁻ | | | | | |
| SO₄²⁻ + 6H₂O + | −0.22 | Na₂SO₄, MgSO₄, | | Anode | Aqueous, |
| 8e⁻ ↔ H₂S + | | K₂SO₄, (NH₄)₂SO₄ | | | gas |
| 10OH⁻ | | | | | |
| PO₄³⁻ + 2H₂O + | −1.05 | Na₃PO₄, K₂PO₄ | | Anode | Aqueous |
| 2e⁻ ↔ HPO₃²⁻ + | | | | | |
| 3OH⁻ | | | | | |
| HPO₃⁻³ + H₂O + | −0.93 | Na₂HPO₃, | | Anode | Aqueous |
| 2e⁻ ↔ HPO₂⁻³ + | | (NH₄)₂HPO₃ | | | |
| 2OH⁻ | | | | | |

As shown in Table 1, in some embodiments, ammonia may be oxidized during discharging of an electrochemical cell to generate nitrates and/or nitrites, which may be reduced during charging of the cell to generate ammonia. In addition, similar oxidation and reduction reactions of sulfur species may also occur during charging and discharging of an electrochemical cell.

The following Table 2 includes other electrode reactions that may be used in to store and discharge power in electrochemical cells of the present disclosure.

TABLE 2

| Half Reaction | E⁰ (V) | Reagent | Electrode | Phase |
|---|---|---|---|---|
| H₂O + ½ O₂ + | 0.40 | O₂ | Cathode | Gas |
| 2e⁻ ↔ 2OH⁻ | | | | |
| Fe³⁺ + e⁻ ↔ Fe²⁺ | 0.77 | FeCl₂ | Cathode | Aqueous |
| Cl₂ + e⁻ ↔ 2Cl⁻ | 1.34 | FeCl₂ | Cathode | Aqueous, |
| | | | | Gas |
| Br₂ + e⁻ ↔ 2Br⁻ | 1.08 | FeBr₂ | Cathode | Aqueous, |
| | | | | Liquid |
| MnO₂ + 2H₂O + 2e⁻ ↔ | 0.56 | MnO₂ | Cathode | Solid |
| Mn(OH)₂ + 2OH⁻ | | | | |

According to various embodiments, the energy capacity of a battery can be increased at a low marginal cost, which enables energy storage for long durations. Electrochemical energy is stored in a concentrated aqueous solution (containing dissolved oxyanion and hydroxide species) and air (containing molecular oxygen). In some embodiments, the aqueous solution may comprise or consist of water and a low-cost chemical feedstock. Therefore, the anode energy capacity can be increased at a low cost by increasing the volume of this low-cost solution. Meanwhile, the air cathode has an indefinite supply of oxygen. The scalability of energy capacity allows the energy storage device to deliver power for long durations (>8 hrs) at a low system cost.

Another advantage of the present disclosure is its limited potential for self-discharge. The aqueous electrolyte may include of a mixture of oxyanions at various oxidation states. Due to the stability of these species, all of these species can remain in the electrolyte simultaneously without undergoing self-discharge reactions. The system can remain in a charged state for long periods of time, on the order of weeks, months, and years. This enables the seasonal and inter-year variability of abundant but non-dispatchable energy sources such as wind, solar, or hydroelectric power to be smoothed. However, the present disclosure is not restricted to use over long durations and may be used over any charge or discharge duration to which a storage battery may be applied.

As the present disclosure can use common chemical feedstocks as energy storage media, it provides for greater operational flexibility than other energy storage technologies. For example, nitrites or ammonia (charged state species) may be generated by the intended energy storing process, or they may be sourced from any other available sources. Furthermore, the ammonia (or other storage chemical) synthesized by the energy storing processes, can be either used as a fuel for the electricity producing step or it may be used in other chemical processes or sold as a commodity chemical Ammonia is most commonly produced today by the Haber-Bosch process, a thermochemical transformation which has been practiced on an industrial scale since the early twentieth century. Thus, the present technology provides advantages in flexible operation.

The theoretical volumetric energy density of the various embodiments of the present disclosure is also attractive. Consider the non-limiting case of a battery with an aqueous nitrate solution anode and air cathode. The charge storing capacity of concentrated aqueous sodium nitrate solution (10 M) is 214 Wh/L. This volumetric density is within the range of lithium ion technologies (100-200 Wh/L) and significantly higher than that of pumped hydro (0.25-1 Wh/L), the incumbent long duration storage technology.

Another advantage of the present disclosure may be improved safety. The electrolytes of various embodiments do not require flammable organic solvents. For example, aqueous electrolyte solutions including oxyanions pose limited fire risk, as compared to conventional electrolytes.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems, batteries for SDES systems, and/or batteries for systems needing power delivery for any time period. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

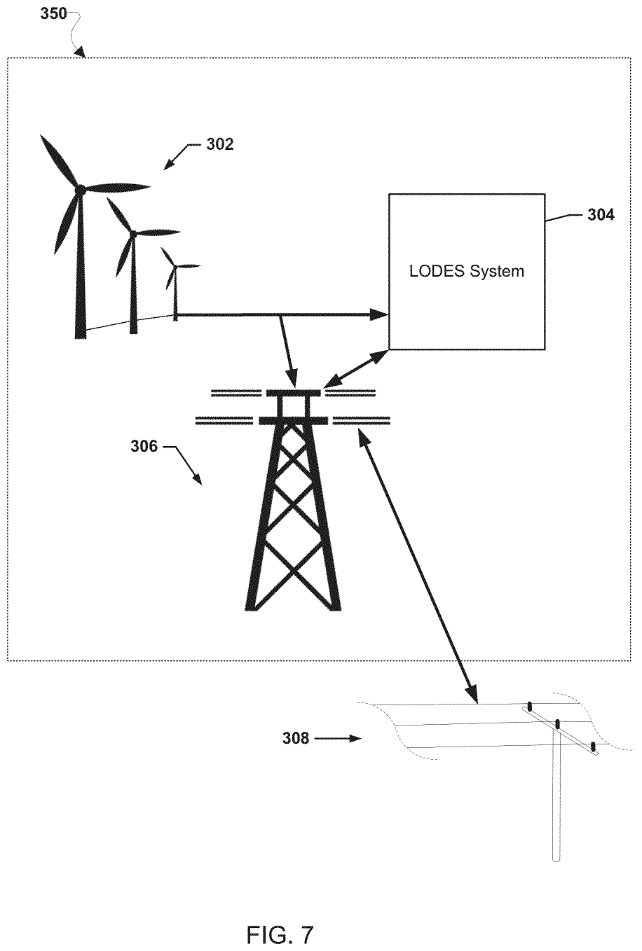

FIGS. 7-15 illustrate various example systems in which one or more aspects of the various embodiments may be used as part of bulk energy storage systems, such as LODES systems, SDES systems, systems needing power delivery for any time period, etc. For example, various embodiments described herein with reference to FIGS. 1-6B, such as electrochemical cells (or batteries) 100, 200, 300, 400, etc., may be used as batteries for bulk energy storage systems, such as LODES systems, SDES systems, systems needing power delivery for any time period, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc. As further examples, various embodiments described herein with reference to FIGS. 1A-3, such as electrochemical cells (or batteries) 100, 200, 300, 400, etc., may be used as batteries for backup power systems, such as backup power systems for telecommunications, data centers, electronic devices, transportation signals, medical facilities, or buildings. The duration of power delivery from the electrochemical cells (or batteries) 100, 200, 300, 400, etc. may be of any duration. The durations of energy storage and/or power delivery described herein generally, and specifically with reference to FIGS. 7-15, are provided merely as examples and are not intended to be limiting.

FIG. 7 illustrates an example system in which one or more aspects of the various embodiments may be used as part of bulk energy storage system. While FIG. 7 is discussed in relation to an example LODES system 304, the durations of energy storage and/or power delivery described with reference to FIG. 7 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to the grid 308. The wind farm 302 may generate power and the wind farm 302 may output generated power to the LODES system 304 and/or the transmission facilities 306. The LODES system 304 may store power received from the wind farm 302 and/or the transmission facilities 306. The LODES system 304 may output stored power to the transmission facilities 306. The transmission facilities 306 may output power received from one or both of the wind farm 302 and LODES system 304 to the grid 308 and/or may receive power from the grid 308 and output that power to the LODES system 304. Together the wind farm 302, the LODES system 304, and the transmission facilities 306 may constitute a power plant 350 that may be a combined power generation, transmission, and storage system. The power generated by the wind farm 302 may be directly fed to the grid 308 through the transmission facilities 306, or may be first stored in the LODES system 304. In certain cases the power supplied to the grid 308 may come entirely from the wind farm 302, entirely from the LODES system 304, or from a combination of the wind farm 302 and the LODES system 304. The dispatch of power from the combined wind farm 302 and LODES system 304 power plant 350 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 350, the LODES system 304 may be used to reshape and “firm” the power produced by the wind farm 302. In one such example, the wind farm 302 may have a peak generation output (capacity) of 260 megawatts (MW) and a capacity factor (CF) of 41%. The LODES system 304 may have a power rating (capacity) of 106 MW, a rated duration (energy/power ratio) of 150 hours (h), and an energy rating of 15,900 megawatt hours (MWh). In another such example, the wind farm 302 may have a peak generation output (capacity) of 300 MW and a capacity factor (CF) of 41%. The LODES system 304 may have a power rating of 106 MW, a rated duration (energy/power ratio) of 200 h and an energy rating of 21,200 MWh. In another such example, the wind farm 302 may have a peak generation output (capacity) of 176 MW and a capacity factor (CF) of 53%. The LODES system 304 may have a power rating (capacity) of 88 MW, a rated duration (energy/power ratio) of 150 h and an energy rating of 13,200 MWh. In another such example, the wind farm 302 may have a peak generation output (capacity) of 277 MW and a capacity factor (CF) of 41%. The LODES system 304 may have a power rating (capacity) of 97 MW, a rated duration (energy/power ratio) of 50 h and an energy rating of 4,850 MWh. In another such example, the wind farm 302 may have a peak generation output (capacity) of 315 MW and a capacity factor (CF) of 41%. The LODES system 304 may have a power rating (capacity) of 110 MW, a rated duration (energy/power ratio) of 25 h and an energy rating of 2,750 MWh.

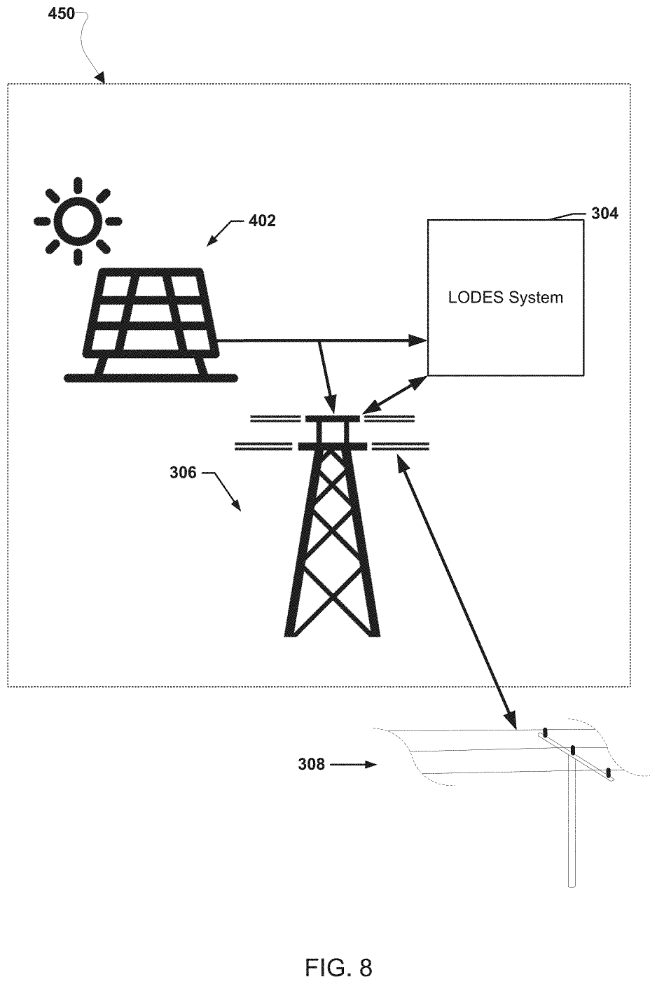

FIG. 8 illustrates an example system in which one or more aspects of the various embodiments may be used as part of bulk energy storage system. While FIG. 8 is discussed in relation to an example LODES system 304, the durations of energy storage and/or power delivery described with reference to FIG. 8 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The system of FIG. 8 may be similar to the system of FIG. 7, except a photovoltaic (PV) farm 402 may be substituted for the wind farm 302. The LODES system 304 may be electrically connected to the PV farm 402 and one or more transmission facilities 306. The PV farm 402 may be electrically connected to the transmission facilities 306. The transmission facilities 306 may be electrically connected to the grid 308. The PV farm 402 may generate power and the PV farm 402 may output generated power to the LODES system 304 and/or the transmission facilities 306. The LODES system 304 may store power received from the PV farm 402 and/or the transmission facilities 306. The LODES system 304 may output stored power to the transmission facilities 306. The transmission facilities 306 may output power received from one or both of the PV farm 402 and LODES system 304 to the grid 308 and/or may receive power from the grid 308 and output that power to the LODES system 304. Together the PV farm 402, the LODES system 304, and the transmission facilities 306 may constitute a power plant 450 that may be a combined power generation, transmission, and storage system. The power generated by the PV farm 402 may be directly fed to the grid 308 through the transmission facilities 306, or may be first stored in the LODES system 304. In certain cases the power supplied to the grid 308 may come entirely from the PV farm 402, entirely from the LODES system 304, or from a combination of the PV farm 402 and the LODES system 304. The dispatch of power from the combined PV farm 402 and LODES system 304 power plant 450 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 450, the LODES system 304 may be used to reshape and “firm” the power produced by the PV farm 402. In one such example, the PV farm 402 may have a peak generation output (capacity) of 490 MW and a capacity factor (CF) of 24%. The LODES system 304 may have a power rating (capacity) of 340 MW, a rated duration (energy/power ratio) of 150 h and an energy rating of 51,000 MWh. In another such example, the PV farm 402 may have a peak generation output (capacity) of 680 MW and a capacity factor (CF) of 24%. The LODES system 304 may have a power rating (capacity) of 410 MW, a rated duration (energy/power ratio) of 200 h, and an energy rating of 82,000 MWh. In another such example, the PV farm 402 may have a peak generation output (capacity) of 330 MW and a capacity factor (CF) of 31%. The LODES system 304 may have a power rating (capacity) of 215 MW, a rated duration (energy/power ratio) of 150 h, and an energy rating of 32,250 MWh. In another such example, the PV farm 402 may have a peak generation output (capacity) of 510 MW and a capacity factor (CF) of 24%. The LODES system 304 may have a power rating (capacity) of 380 MW, a rated duration (energy/power ratio) of 50 h, and an energy rating of 19,000 MWh. In another such example, the PV farm 402 may have a peak generation output (capacity) of 630 MW and a capacity factor (CF) of 24%. The LODES system 304 may have a power rating (capacity) of 380 MW, a rated duration (energy/power ratio) of 25 h, and an energy rating of 9,500 MWh.

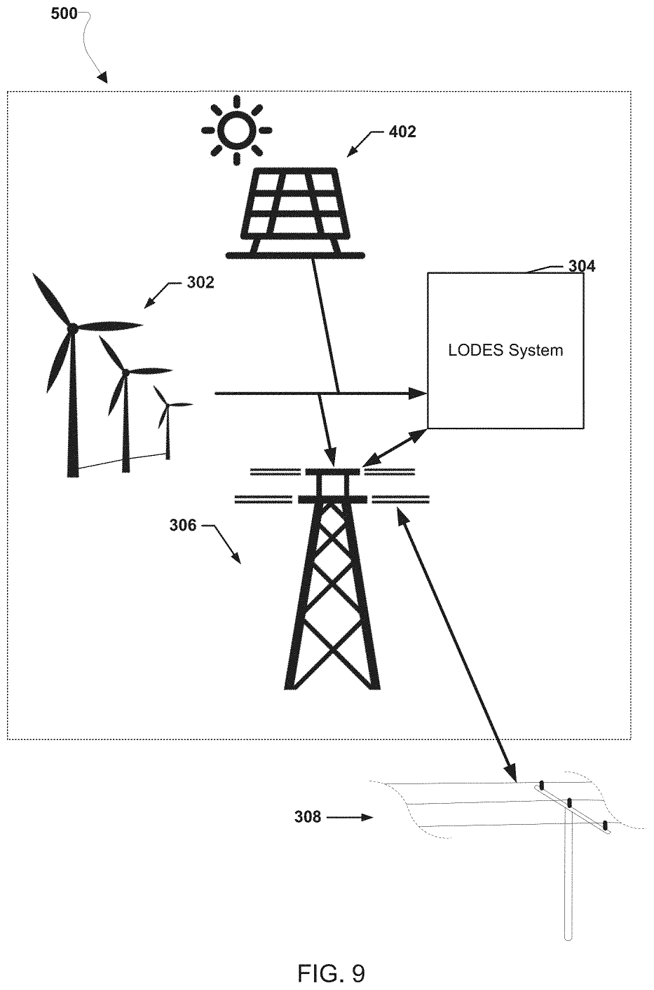

FIG. 9 illustrates an example system in which one or more aspects of the various embodiments may be used as part of bulk energy storage system. While FIG. 9 is discussed in relation to an example LODES system 304, the durations of energy storage and/or power delivery described with reference to FIG. 9 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The system of FIG. 9 may be similar to the systems of FIGS. 7 and 8, except the wind farm 302 and the photovoltaic (PV) farm 402 may both be power generators working together in the power plant 500. Together the PV farm 402, wind farm 302, the LODES system 304, and the transmission facilities 306 may constitute the power plant 500 that may be a combined power generation, transmission, and storage system. The power generated by the PV farm 402 and/or the wind farm 302 may be directly fed to the grid 308 through the transmission facilities 306, or may be first stored in the LODES system 304. In certain cases the power supplied to the grid 308 may come entirely from the PV farm 402, entirely from the wind farm 302, entirely from the LODES system 304, or from a combination of the PV farm 402, the wind farm 302, and the LODES system 304. The dispatch of power from the combined wind farm 302, PV farm 402, and LODES system 304 power plant 500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 500, the LODES system 304 may be used to reshape and “firm” the power produced by the wind farm 302 and the PV farm 402. In one such example, the wind farm 302 may have a peak generation output (capacity) of 126 MW and a capacity factor (CF) of 41% and the PV farm 402 may have a peak generation output (capacity) of 126 MW and a capacity factor (CF) of 24%. The LODES system 304 may have a power rating (capacity) of 63 MW, a rated duration (energy/power ratio) of 150 h, and an energy rating of 9,450 MWh. In another such example, the wind farm 302 may have a peak generation output (capacity) of 170 MW and a capacity factor (CF) of 41% and the PV farm 402 may have a peak generation output (capacity) of 110 MW and a capacity factor (CF) of 24%. The LODES system 304 may have a power rating (capacity) of 57 MW, a rated duration (energy/power ratio) of 200 h, and an energy rating of 11,400 MWh. In another such example, the wind farm 302 may have a peak generation output (capacity) of 105 MW and a capacity factor (CF) of 51% and the PV farm 402 may have a peak generation output (capacity) of 70 MW and a capacity factor (CF) of 31 The LODES system 304 may have a power rating (capacity) of 61 MW, a rated duration (energy/power ratio) of 150 h, and an energy rating of 9,150 MWh. In another such example, the wind farm 302 may have a peak generation output (capacity) of 135 MW and a capacity factor (CF) of 41% and the PV farm 402 may have a peak generation output (capacity) of 90 MW and a capacity factor (CF) of 24%. The LODES system 304 may have a power rating (capacity) of 68 MW, a rated duration (energy/power ratio) of 50 h, and an energy rating of 3,400 MWh. In another such example, the wind farm 302 may have a peak generation output (capacity) of 144 MW and a capacity factor (CF) of 41% and the PV farm 402 may have a peak generation output (capacity) of 96 MW and a capacity factor (CF) of 24%. The LODES system 304 may have a power rating (capacity) of 72 MW, a rated duration (energy/power ratio) of 25 h, and an energy rating of 1,800 MWh.

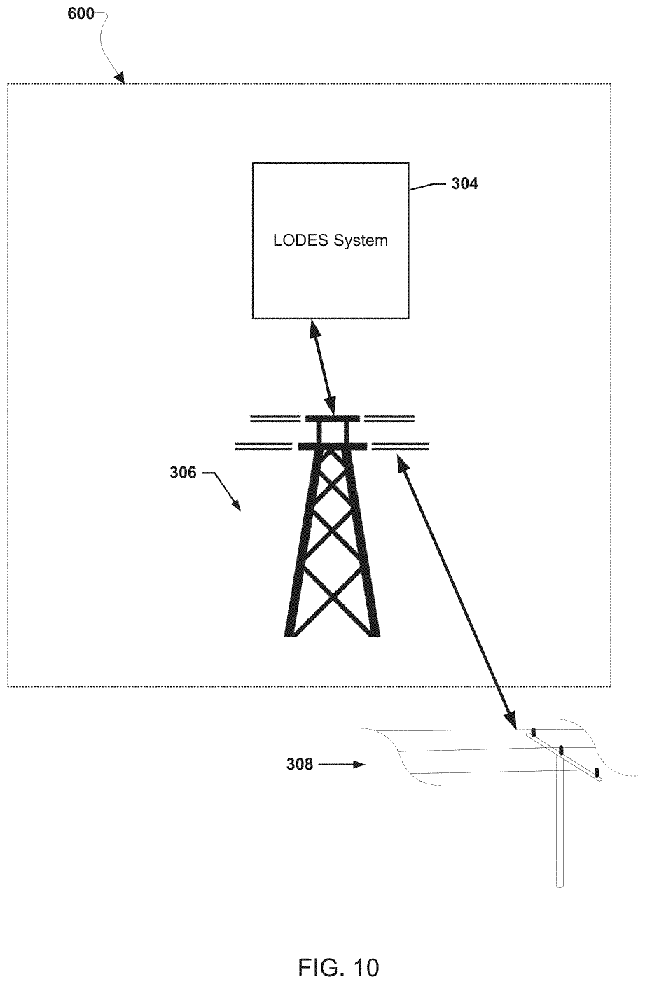

FIG. 10 illustrates an example system in which one or more aspects of the various embodiments may be used as part of bulk energy storage system. While FIG. 10 is discussed in relation to an example LODES system 304, the durations of energy storage and/or power delivery described with reference to FIG. 10 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to one or more transmission facilities 306. In this manner, the LODES system 304 may operate in a “stand-alone” manner to arbiter energy around market prices and/or to avoid transmission constraints. The LODES system 304 may be electrically connected to one or more transmission facilities 306. The transmission facilities 306 may be electrically connected to the grid 308. The LODES system 304 may store power received from the transmission facilities 306. The LODES system 304 may output stored power to the transmission facilities 306. The transmission facilities 306 may output power received from the LODES system 304 to the grid 308 and/or may receive power from the grid 308 and output that power to the LODES system 304.

Together the LODES system 304 and the transmission facilities 306 may constitute a power plant 600. As an example, the power plant 600 may be situated downstream of a transmission constraint, close to electrical consumption. In such an example downstream situated power plant 600, the LODES system 304 may have a duration of 24 h to 500 h and may undergo one or more full discharges a year to support peak electrical consumptions at times when the transmission capacity is not sufficient to serve customers. Additionally in such an example downstream situated power plant 600, the LODES system 304 may undergo several shallow discharges (daily or at higher frequency) to arbiter the difference between nighttime and daytime electricity prices and reduce the overall cost of electrical service to customer. As a further example, the power plant 600 may be situated upstream of a transmission constraint, close to electrical generation. In such an example upstream situated power plant 600, the LODES system 304 may have a duration of 24 h to 500 h and may undergo one or more full charges a year to absorb excess generation at times when the transmission capacity is not sufficient to distribute the electricity to customers. Additionally in such an example upstream situated power plant 600, the LODES system 304 may undergo several shallow charges and discharges (daily or at higher frequency) to arbiter the difference between nighttime and daytime electricity prices and maximize the value of the output of the generation facilities.

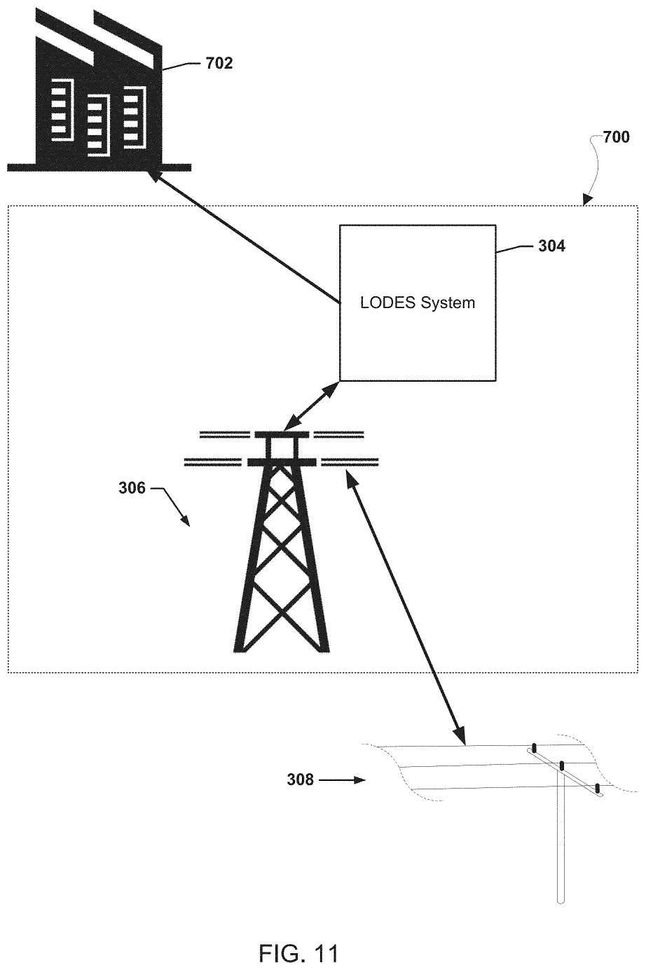

FIG. 11 illustrates an example system in which one or more aspects of the various embodiments may be used as part of bulk energy storage system. While FIG. 11 is discussed in relation to an example LODES system 304, the durations of energy storage and/or power delivery described with reference to FIG. 11 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a commercial and industrial (C&I) customer 702, such as a data center, factory, etc. The LODES system 304 may be electrically connected to one or more transmission facilities 306. The transmission facilities 306 may be electrically connected to the grid 308. The transmission facilities 306 may receive power from the grid 308 and output that power to the LODES system 304. The LODES system 304 may store power received from the transmission facilities 306. The LODES system 304 may output stored power to the C&I customer 702. In this manner, the LODES system 304 may operate to reshape electricity purchased from the grid 308 to match the consumption pattern of the C&I customer 702.

Together, the LODES system 304 and transmission facilities 306 may constitute a power plant 700. As an example, the power plant 700 may be situated close to electrical consumption, i.e., close to the C&I customer 702, such as between the grid 308 and the C&I customer 702. In such an example, the LODES system 304 may have a duration of 24 h to 500 h and may buy electricity from the markets and thereby charge the LODES system 304 at times when the electricity is cheaper. The LODES system 304 may then discharge to provide the C&I customer 702 with electricity at times when the market price is expensive, therefore offsetting the market purchases of the C&I customer 702. As an alternative configuration, rather than being situated between the grid 308 and the C&I customer 702, the power plant 700 may be situated between a renewable source, such as a PV farm, wind farm, etc., and the transmission facilities 306 may connect to the renewable source. In such an alternative example, the LODES system 304 may have a duration of 24 h to 500 h, and the LODES system 304 may charge at times when renewable output may be available. The LODES system 304 may then discharge to provide the C&I customer 702 with renewable generated electricity so as to cover a portion, or the entirety, of the C&I customer 702 electricity needs.

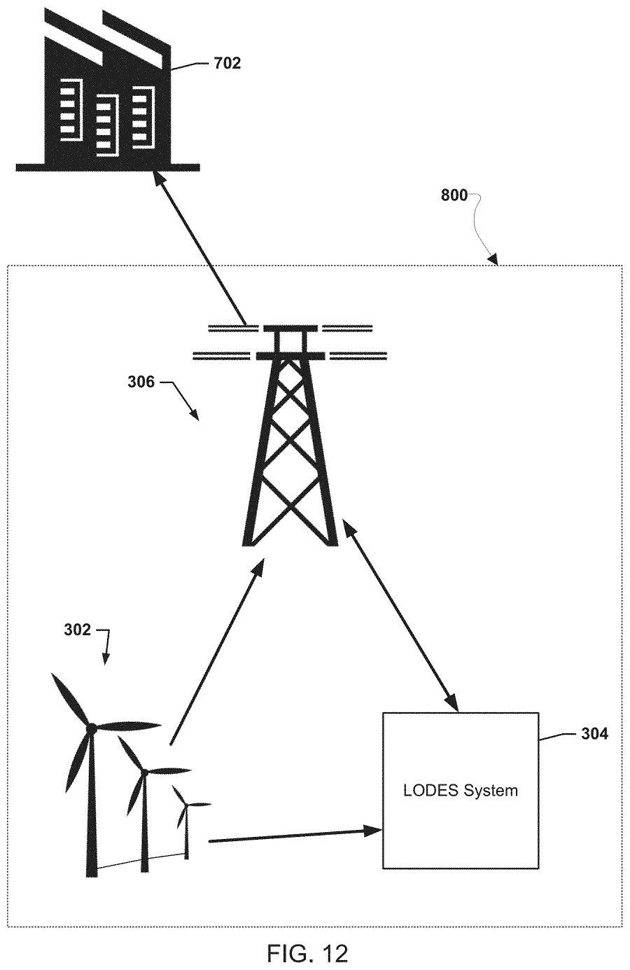

FIG. 12 illustrates an example system in which one or more aspects of the various embodiments may be used as part of bulk energy storage system. While FIG. 12 is discussed in relation to an example LODES system 304, the durations of energy storage and/or power delivery described with reference to FIG. 12 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to a C&I customer 702. The wind farm 302 may generate power and the wind farm 302 may output generated power to the LODES system 304 and/or the transmission facilities 306. The LODES system 304 may store power received from the wind farm 302.

The LODES system 304 may output stored power to the transmission facilities 306. The transmission facilities 306 may output power received from one or both of the wind farm 302 and LODES system 304 to the C&I customer 702. Together the wind farm 302, the LODES system 304, and the transmission facilities 306 may constitute a power plant 800 that may be a combined power generation, transmission, and storage system. The power generated by the wind farm 302 may be directly fed to the C&I customer 702 through the transmission facilities 306, or may be first stored in the LODES system 304. In certain cases, the power supplied to the C&I customer 702 may come entirely from the wind farm 302, entirely from the LODES system 304, or from a combination of the wind farm 302 and the LODES system 304. The LODES system 304 may be used to reshape the electricity generated by the wind farm 302 to match the consumption pattern of the C&I customer 702. In one such example, the LODES system 304 may have a duration of 24 h to 500 h and may charge when renewable generation by the wind farm 302 exceeds the C&I customer 702 load. The LODES system 304 may then discharge when renewable generation by the wind farm 302 falls short of C&I customer 702 load so as to provide the C&I customer 702 with a firm renewable profile that offsets a fraction, or all of, the C&I customer 702 electrical consumption.

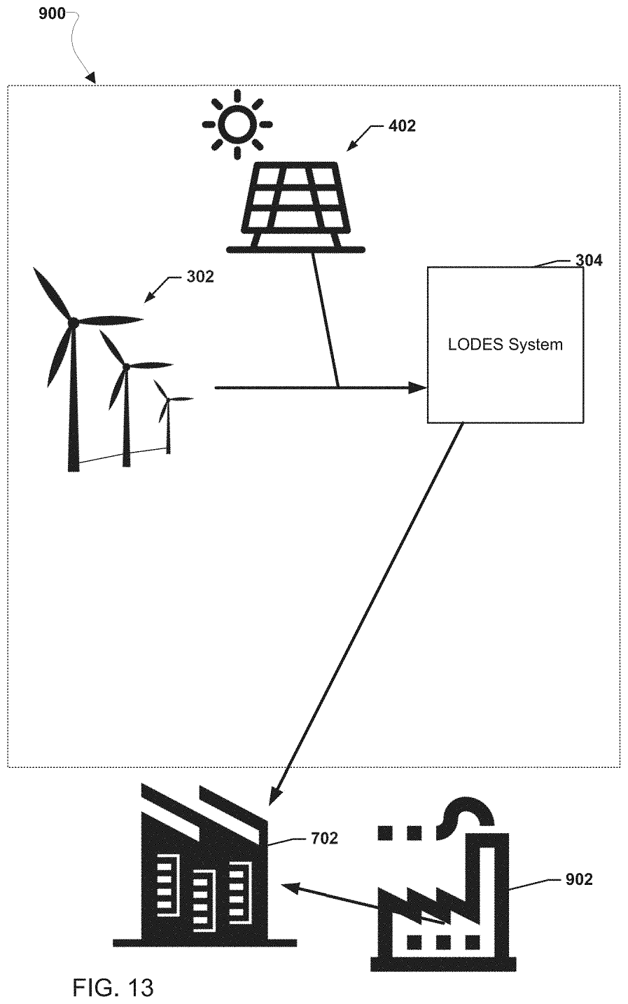

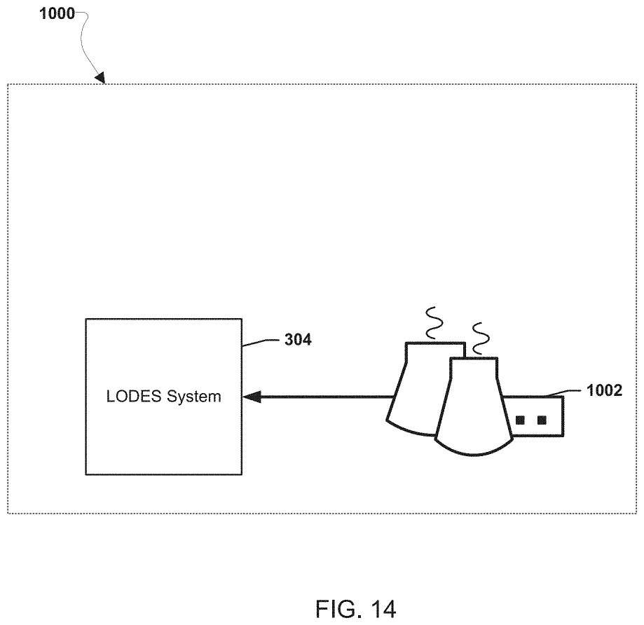

FIG. 13 illustrates an example system in which one or more aspects of the various embodiments may be used as part of bulk energy storage system. While FIG. 13 is discussed in relation to an example LODES system 304, the durations of energy storage and/or power delivery described with reference to FIG. 13 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be part of a power plant 900 that is used to integrate large amounts of renewable generation in microgrids and harmonize the output of renewable generation by, for example a PV farm 402 and wind farm 302, with existing thermal generation by, for example a thermal power plant 902 (e.g., a gas plant, a coal plant, a diesel generator set, etc., or a combination of thermal generation methods), while renewable generation and thermal generation supply the C&I customer 702 load at high availability. Microgrids, such as the microgrid constituted by the power plant 900 and the thermal power plant 902, may provide availability that is 90% or higher. The power generated by the PV farm 402 and/or the wind farm 302 may be directly fed to the C&I customer 702, or may be first stored in the LODES system 304.

In certain cases the power supplied to the C&I customer 702 may come entirely from the PV farm 402, entirely from the wind farm 302, entirely from the LODES system 304, entirely from the thermal power plant 902, or from any combination of the PV farm 402, the wind farm 302, the LODES system 304, and/or the thermal power plant 902. As examples, the LODES system 304 of the power plant 900 may have a duration of 24 h to 500 h. As a specific example, the C&I customer 702 load may have a peak of 100 MW, the LODES system 304 may have a power rating of 14 MW and duration of 150 h, natural gas may cost $6/million British thermal units (MMBTU), and the renewable penetration may be 58%. As another specific example, the C&I customer 702 load may have a peak of 100 MW, the LODES system 304 may have a power rating of 25 MW and duration of 150 h, natural gas may cost $8/MMBTU, and the renewable penetration may be 65%.

FIG. 14 illustrates an example system in which one or more aspects of the various embodiments may be used as part of bulk energy storage system. While FIG. 14 is discussed in relation to an example LODES system 304, the durations of energy storage and/or power delivery described with reference to FIG. 14 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be used to augment a nuclear plant 1002 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 1000 constituted by the combined LODES system 304 and nuclear plant 1002. The nuclear plant 1002 may operate at high capacity factor and at the highest efficiency point, while the LODES system 304 may charge and discharge to effectively reshape the output of the nuclear plant 1002 to match a customer electrical consumption and/or a market price of electricity. As examples, the LODES system 304 of the power plant 1000 may have a duration of 24 h to 500 h. In one specific example, the nuclear plant 1002 may have 1,000 MW of rated output and the nuclear plant 1002 may be forced into prolonged periods of minimum stable generation or even shutdowns because of depressed market pricing of electricity. The LODES system 304 may avoid facility shutdowns and charge at times of depressed market pricing; and the LODES system 304 may subsequently discharge and boost total output generation at times of inflated market pricing.

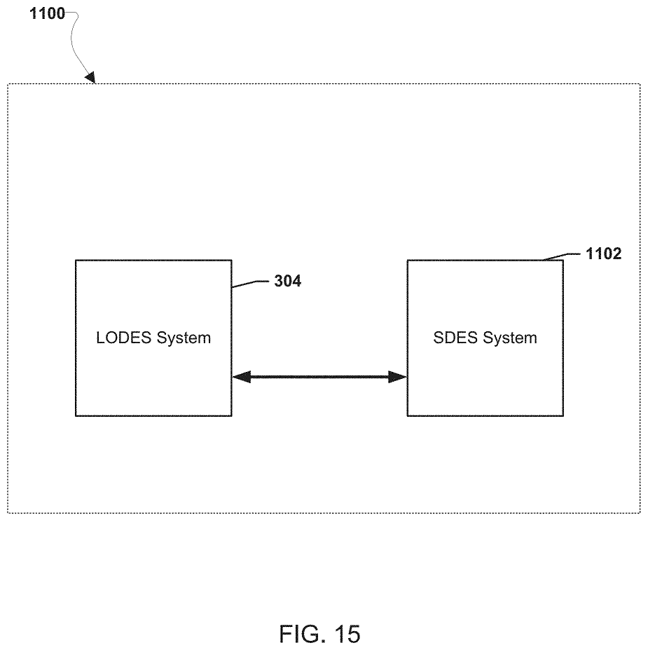

FIG. 15 illustrates an example system in which one or more aspects of the various embodiments may be used as part of bulk energy storage system. While FIG. 15 is discussed in relation to an example LODES system 304 and SDES system 1102, the durations of energy storage and/or power delivery described with reference to FIG. 15 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may operate in tandem with a SDES system 1102. Together the LODES system 304 and SDES system 1102 may constitute a power plant 1100. As an example, the LODES system 304 and SDES system 1102 may be co-optimized whereby the LODES system 304 may provide various services, including long-duration back-up and/or bridging through multi-day fluctuations (e.g., multi-day fluctuations in market pricing, renewable generation, electrical consumption, etc.), and the SDES system 1102 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 1102 may have durations of less than 10 hours and round-trip efficiencies of greater than 80%. The LODES system 304 may have durations of 24 h to 500 h and round-trip efficiencies of greater than 40%. In one such example, the LODES system 304 may have a duration of 150 hours and support customer electrical consumption for up to a week of renewable under-generation. The LODES system 304 may also support customer electrical consumption during intra-day under-generation events, augmenting the capabilities of the SDES system 1102. Further, the SDES system 1102 may supply customers during intra-day under-generation events and provide power conditioning and quality services such as voltage control and frequency regulation.

Various examples are provided below to illustrate aspects of the various embodiments. Example 1. An electrode which performs electrochemical oxidation and reduction of oxyanions. Example 2. The electrode of example 1 which performs electrochemical conversions between nitrate, nitrite, and ammonia, the electrode comprising an aqueous solution of sodium nitrate, potassium nitrate, lithium nitrate, magnesium nitrate, calcium nitrate, calcium ammonium nitrate, sodium nitrite, potassium nitrite, lithium nitrite, or mixtures thereof. Example 3. The electrode of example 1 which performs electrochemical conversions between sulfate, sulfite, hyposulfite, thiosulfate, dithionite, and hydrogen sulfide, the electrode comprising an aqueous solution of sodium sulfate, potassium sulfate, magnesium sulfate, ammonium sulfate, sodium sulfite, potassium sulfite, or mixtures thereof. Example 4. The electrode of example 1 which performs electrochemical conversions between phosphate, phosphite, and hypophosphite, the electrode comprising an aqueous solution of sodium phosphate, potassium phosphate, disodium hydrogen phosphite, diammonium hydrogen phosphite, or mixtures thereof. Example 5. An energy storage device in which: the device charges with electrical energy by an electrochemical process; the device releases electrical energy by an electrochemical process; and one or more electrodes are as described by examples 2, 3, or 4, wherein an electrochemical reaction of oxyanions occurs. Example 6. The device in example 5 wherein the cathode uses atmospheric oxygen and is comprised either of: a single bifunctional electrode with performs both oxidation and reduction of atmospheric oxygen; or a dual electrode cathode, with distinct electrodes to perform oxidation and reduction of atmospheric oxygen. Example 7. The device in example 5 wherein the cathode comprises of iron (III)/iron (II) cations, molecular chlorine/chloride, molecular bromine/bromide, and/or manganese (II) oxide/manganese (II) hydroxide. Example 8. The device in example 5 wherein both the anode and cathode comprise aqueous solutions of oxyanions, separated by an ion-exchange membrane. Example 9. The device in example 5 wherein reduction of oxyanions is performed by microbial activity. Example 10. The device in example 5 wherein the energy storage media is cycled in a flow battery. Example 11. A bulk energy storage system, comprising at least one energy storage device of any of examples 5-10; and/or at least one energy storage device having an electrode of any of examples 1-4. Example 12. The bulk energy storage system of example 11, wherein the bulk energy storage system is a long or ultra-long duration energy storage system.

Example A1. An energy storage device, comprising: at least one electrode configured such that electrochemical oxidation and reduction of one or more redox-active oxyanions occurs during charging and/or discharging of the energy storage device. Example A2. The energy storage device of example A1, wherein at least one of the one or more redox-active oxyanions comprise nitrate (NO₃²⁻), nitrite (NO₂²⁻), sulfate (SO₄²⁻), sulfite (SO₃²⁻), hyposulfite (SO₂²⁻), phosphate (PO₄³⁻), phosphite (PO₃³⁻), hypophosphite (PO₂³⁻), peroxodisulfate (S₂O₈²⁻), ammonia (NH₃), ammonium (NH₄⁺), S₂⁻, HS₂, chlorite (ClO₂⁻), chlorate (ClO₃⁻), chlorine dioxide (ClO₂), or hypochlorite (ClO⁻). Example A3. The energy storage device of example A1, wherein the energy storage device is configured such that electrochemical conversions between nitrate, nitrite, and/or ammonia occur during charging and/or discharging of the energy storage device. Example A4. The energy storage device of example A3, wherein the electrode comprises an aqueous solution of sodium nitrate, potassium nitrate, lithium nitrate, magnesium nitrate, calcium nitrate, calcium ammonium nitrate, sodium nitrite, potassium nitrite, lithium nitrite, or mixtures thereof. Example A5. The energy storage device of example A1, wherein the energy storage device is configured such that electrochemical conversions between sulfate, sulfite, hyposulfite, thiosulfate, dithionite, and/or hydrogen sulfide occur during charging and/or discharging of the energy storage device. Example A6. The energy storage device of example A5, wherein the electrode comprises an aqueous solution of an aqueous solution of sodium sulfate, potassium sulfate, magnesium sulfate, ammonium sulfate, sodium sulfite, potassium sulfite, or mixtures thereof. Example A7. The energy storage device of example A1, wherein the energy storage device is configured such that electrochemical conversions between phosphate, phosphite, and hypophosphite occur during charging and/or discharging of the energy storage device. Example A8. The energy storage device of example A1, wherein the electrode comprises an aqueous solution of sodium phosphate, potassium phosphate, disodium hydrogen phosphite, diammonium hydrogen phosphite, or mixtures thereof. Example A9. The energy storage device of example A1, wherein the one or more redox-active oxyanions comprise nitrate and/or nitrite anions. Example A10. The energy storage device of any of examples A1-A9, wherein the electrode comprises a bifunctional air electrode configured to perform oxygen reduction reactions and oxygen evolution reactions. Example A11. The energy storage device of any of examples A1-A9, wherein the electrode comprises a dual electrode configuration comprising: an oxygen reduction reaction (ORR) electrode; and an oxygen evolution reaction (OER) electrode separate from the ORR electrode. Example A12. The energy storage device of any of examples A1-A11, wherein the electrode is a cathode that comprises a cathode active material selected from iron (III)/iron (II) cations, molecular chlorine/chloride, molecular bromine/bromide, manganese (II) oxide/manganese (II) hydroxide, or any combination thereof. Example A13. The energy storage device of any of examples A1-A12, comprising: an anode; and a cathode, wherein the anode and/or the cathode are the electrode according to examples A1-A12 and both the anode and the cathode comprise aqueous solutions of oxyanions; and an ion exchange membrane disposed between the anode and the cathode. Example A14. The energy storage device of any of examples A1-A13, further comprising: one or more biomolecules, one or more enzymes, and/or one or more microorganisms disposed within the energy storage device, wherein the one or more biomolecules, the one or more enzymes, and/or the one or more microorganisms aid in oxidation and/or reduction of the one or more redox-active oxyanions during charging and/or discharging of the energy storage device. Example A15. The energy storage device of example A14, wherein the one or more biomolecules, one or more enzymes, and/or one or more microorganisms disposed within the energy storage device are at least one microorganism. Example A16. The energy storage device of example A15, wherein the at least one microorganism is a bacteria. Example A17. The energy storage device of example A16, wherein the bacteria is a sulphate-reducing bacteria. Example A18. The energy storage device of any of examples A1-A17, wherein the energy storage device is a flow battery. Example A19. An energy storage device, comprising: negative electrode materials comprising sulfate and sulfite; and positive electrode materials comprising oxygen, wherein the energy storage device is configured to be rechargeable. Example A20. A bulk energy storage system, comprising one or more energy storage devices of any of examples A1-A19. Example A21. The bulk energy storage system of example A20, wherein the bulk energy storage system is a long or ultra-long duration energy storage system.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. An energy storage device, comprising:
at least one electrode configured such that electrochemical oxidation and reduction of one or more redox-active oxyanions occurs during charging and/or discharging of the energy storage device.

2. The energy storage device of claim 1, wherein at least one of the one or more redox-active oxyanions comprise nitrate (NO₃²⁻), nitrite (NO₂²⁻), sulfate (SO₄²⁻), sulfite (SO₃²⁻), hyposulfite (SO₂²⁻), phosphate (PO₄³⁻), phosphite (PO₃³⁻), hypophosphite (PO₂³⁻), peroxodisulfate (S₂O₈²⁻), ammonia (NH₃), ammonium (NH₄⁺), S₂⁻, HS₂, chlorite (ClO₂⁻), chlorate (ClO₃⁻), chlorine dioxide (ClO₂), or hypochlorite (ClO⁻).

3. The energy storage device of claim 1, wherein the energy storage device is configured such that electrochemical conversions between nitrate, nitrite, and/or ammonia occur during charging and/or discharging of the energy storage device.

4. The energy storage device of claim 3, wherein the electrode comprises an aqueous solution of sodium nitrate, potassium nitrate, lithium nitrate, magnesium nitrate, calcium nitrate, calcium ammonium nitrate, sodium nitrite, potassium nitrite, lithium nitrite, or mixtures thereof.

5. The energy storage device of claim 1, wherein the energy storage device is configured such that electrochemical conversions between sulfate, sulfite, hyposulfite, thiosulfate, dithionite, and/or hydrogen sulfide occur during charging and/or discharging of the energy storage device.

6. The energy storage device of claim 5, wherein the electrode comprises an aqueous solution of sodium sulfate, potassium sulfate, magnesium sulfate, ammonium sulfate, sodium sulfite, potassium sulfite, or mixtures thereof.

7. The energy storage device of claim 1, wherein the energy storage device is configured such that electrochemical conversions between phosphate, phosphite, and hypophosphite occur during charging and/or discharging of the energy storage device.

8. The energy storage device of claim 1, wherein the electrode comprises an aqueous solution of sodium phosphate, potassium phosphate, disodium hydrogen phosphite, diammonium hydrogen phosphite, or mixtures thereof.

9. The energy storage device of claim 1, wherein the one or more redox-active oxyanions comprise nitrate and/or nitrite anions.

10. The energy storage device of any of claim 1, wherein the electrode comprises a bifunctional air electrode configured to perform oxygen reduction reactions and oxygen evolution reactions.

11. The energy storage device of any of claim 1, wherein the electrode comprises a dual electrode configuration comprising:
an oxygen reduction reaction (ORR) electrode; and
an oxygen evolution reaction (OER) electrode separate from the ORR electrode.

12. The energy storage device of any of claim 1, wherein the electrode is a cathode that comprises a cathode active material selected from iron (III)/iron (II) cations, molecular chlorine/chloride, molecular bromine/bromide, manganese (II) oxide/manganese (II) hydroxide, or any combination thereof.

13. (canceled)

14. The energy storage device of claim 1, further comprising:
one or more biomolecules, one or more enzymes, and/or one or more microorganisms disposed within the energy storage device, wherein the one or more biomolecules, the one or more enzymes, and/or the one or more microorganisms aid in oxidation and/or reduction of the one or more redox-active oxyanions during charging and/or discharging of the energy storage device.

15. The energy storage device of claim 14, wherein the one or more biomolecules, the one or more enzymes, and/or the one or more microorganisms disposed within the energy storage device are at least one microorganism.

16. The energy storage device of claim 15, wherein the at least one microorganism is a bacteria.

17. The energy storage device of claim 16, wherein the bacteria is a sulphate-reducing bacteria.

18. The energy storage device of any of claim 1, wherein the energy storage device is a flow battery.

19. An energy storage device, comprising:
negative electrode materials comprising sulfate and sulfite; and
positive electrode materials comprising oxygen,
wherein the energy storage device is configured to be rechargeable.

20-21. (canceled)
